(19) United States
(12) Patent Application Publication
(10) Pub. No.: US 2005/0220986 A1
(43) Pub. Date: Oct. 6, 2005

(54) Superconductor fabrication processes

(75) Inventors: Venkat Selvamanickam, Wynantskill, NY (US); Yunfei Qiao, Schenectady, NY (US); Kenneth Patrick Lenseth, Wynantskill, NY (US)

Correspondence Address: TOLER & LARSON & ABEL L.L.P., 5000 PLAZA ON THE LAKE STE 265, AUSTIN, TX, 78746, US

(73) Assignee: SuperPower, Inc.

(21) Appl. No.: 10/816,045

(22) Filed: Apr. 1, 2004

(51) Int. Cl. B05D 5/12

(52) U.S. Cl. 427/62; 427/600; 427/569

(57) ABSTRACT

A method of forming a superconductive device is disclosed, which calls for cleaning a substrate having a dimension ratio of not less than about 10², the cleaning including immersing the substrate in a fluid medium and subjecting the substrate to mechanical waves in the fluid medium, and depositing a superconductor layer to overlie the substrate.

### BACKGROUND

1. Field of the Invention

The present invention is generally directed to superconductive articles, and more specifically methods for forming superconductive articles having extended lengths.

2. Description of the Related Art

Superconductor materials have long been known and understood by the technical community. Low-temperature (low-T_{c}) superconductors exhibiting superconductive properties at temperatures requiring use of liquid helium (4.2 K), have been known since about 1911. However, it was not until somewhat recently that oxide-based high-temperature (high-T_{c}) superconductors have been discovered. Around 1986, a first high-temperature superconductor (HTS), having superconductive properties at a temperature above that of liquid nitrogen (77 K) was discovered, namely YBa₂Cu₃O₇₋ₓ (YBCO), followed by development of additional materials over the past 15 years including Bi₂Sr₂Ca₂Cu₃O_{10+y} (BSCCO), and others. The development of high-T_{c} superconductors has brought potential, economically feasible development of superconductor components incorporating such materials, due partly to the cost of operating such superconductors with liquid nitrogen rather than the comparatively more expensive cryogenic infrastructure based on liquid helium.

Of the myriad of potential applications, the industry has sought to develop use of such materials in the power industry, including applications for power generation, transmission, distribution, and storage. In this regard, it is estimated that the inherent resistance of copper-based commercial power components is responsible for quite significant losses in electricity, and accordingly, the power industry stands to gain significant efficiencies based upon utilization of high-temperature superconductors in power components such as transmission and distribution power cables, generators, transformers, and fault current interrupters. In addition, other benefits of high-temperature superconductors in the power industry include an increase in one to two orders of magnitude of power-handling capacity, significant reduction in the size (i.e., footprint) of electric power equipment, reduced environmental impact, greater safety, and increased capacity over conventional technology. While such potential benefits of high-temperature superconductors remain quite compelling, numerous technical challenges continue to exist in the production and commercialization of high-temperature superconductors on a large scale.

Among the many challenges associated with the commercialization of high-temperature superconductors, many exist around the fabrication of a superconducting tape that can be utilized for formation of various power components. A first generation of superconducting tape includes use of the above-mentioned BSCCO high-temperature superconductor. This material is generally provided in the form of discrete filaments, which are embedded in a matrix of noble metal, typically silver. Although such conductors may be made in extended lengths needed for implementation into the power industry (such as on the order of hundreds of meters), due to materials and manufacturing costs, such tapes do not represent a commercially feasible product.

Accordingly, a great deal of interest has been generated in the so-called second-generation HTS tapes that have superior commercial viability. These tapes typically rely on a layered structure, generally including a flexible substrate that provides mechanical support, at least one buffer layer overlying the substrate, the buffer layer optionally containing multiple films, an HTS layer overlying the buffer film, and an electrical stabilizer layer overlying the superconductor layer, typically formed of at least a noble metal. However, to date, numerous engineering and manufacturing challenges remain prior to full commercialization of such second generation-tapes.

Existing technology described in WO 01/08232 and WO 01/26165 has attempted to address numerous processing issues. While the '232 publication discloses conditioning layers overlying a substrate, such as buffer and/or superconductor layers, it fails to address other important processing considerations. The '165 publication relates to treating biaxially textured substrates utilizing an etching process to remove native oxides, prior to epitaxially growing a buffer layer on the cleaned surface. While the '165 publication makes passing reference to non-textured substrates, that is, substrates having an amorphous surface (on which textured layers are provided), the publication is generally limited to process flows using textured substrates and epitaxial growth thereon. In addition, a more robust treatment of substrates, particularly non-textured polycrystalline substrates, is desired in the art to further improve yield and performance of superconducting conductors.

Accordingly, in view of the foregoing, various needs continue to exist in the art of superconductors, and in particular, provision of commercially viable superconducting tapes, methods for forming same, and power components utilizing such superconducting tapes.

### SUMMARY

According to an aspect of the present invention, a method of forming a superconductive device is provided, which includes cleaning a substrate having a dimension ratio of not less than about 10², the cleaning including immersing the substrate in a fluid medium and subjecting the substrate to mechanical waves in the fluid medium, and depositing a superconductor layer to overlie the substrate.

According to another aspect of the present invention, a method of forming a superconductive device includes annealing a substrate having a dimension ratio of not less than about 10², and depositing a superconductor layer to overlie the substrate.

According to another aspect of the present invention, a method of forming a superconductive device includes providing a substrate having a dimension ratio of not less than about 10² and having first and second opposite major surfaces, at least the first opposite major surface being polycrystalline and randomly textured. The method continues with subjecting the first opposite major surface to ion treatment, and depositing a superconductor layer to overlie the first opposite major surface.

According to another aspect of the present invention, a method for treating a substrate for a superconductive device includes polishing the substrate, the substrate having a dimension ratio of not less than about 10², cleaning the substrate, cleaning including immersing the substrate in a fluid medium and subjecting the substrate to mechanical waves in the fluid medium, annealing the substrate, and subjecting the substrate to ion treatment.

### BRIEF DESCRIPTION OF THE DRAWINGS

The present invention may be better understood, and its numerous objects, features, and advantages made apparent to those skilled in the art by referencing the accompanying drawings.

FIGS. 1A-1C illustrate an apparatus for treating a superconductor substrate, including stations for polishing and cleaning such a substrate.

FIG. 2 illustrates an alternative embodiment of an ultrasound chamber according to an aspect of the present invention.

FIG. 3 illustrates an annealing apparatus for annealing a substrate.

FIG. 4 illustrates a plasma cleaning system for plasma treating a substrate.

FIG. 5 illustrates a superconductive article according to an embodiment of the present invention.

The use of the same reference symbols in different drawings indicates similar or identical items.

### DETAILED DESCRIPTION

According to an aspect of the present invention, fabrication of a superconductive article begins with provision of a substrate. The substrate is generally metal-based, and typically, an alloy of at least two metallic elements. Particularly suitable substrate materials include nickel-based metal alloys such as the known Inconel® group of alloys. The Inconel® alloys tend to have desirable thermal, chemical and mechanical properties, including coefficient of expansion, thermal conductivity, Curie temperature, tensile strength, yield strength, and elongation. These metals are generally commercially available in the form of spooled tapes, particularly suitable for superconductor tape fabrication, which typically will utilize reel-to-reel tape handling.

The substrate is typically in a tape-like configuration, having a high dimension ratio. For example, the width of the tape is generally on the order of about 0.4-10 cm, and the length of the tape is typically at least about 100 m, most typically greater than about 500 m. Indeed, embodiments of the present invention provide for superconducting tapes that include substrate 10 having a length on the order of 1 km or above. Accordingly, the substrate may have a dimension ratio which is fairly high, on the order of not less than 10², or even not less than 10³. Certain embodiments are longer, having a dimension ratio of 10⁴ and higher. As used herein, the term ‘dimension ratio’ is used to denote the ratio of the length of the substrate or tape to the next longest dimension, the width of the substrate or tape.

In one embodiment, the substrate is treated so as to have desirable surface properties for subsequent deposition of the constituent layers of the superconductor tape. For example, the surface may be lightly polished to a desired flatness and surface roughness. Additionally, the substrate may be treated to be biaxially textured as is understood in the art, such as by the known RABiTS (roll assisted biaxially textured substrate) technique. However, in other embodiments, the substrate is in the form of a non-textured, polycrystalline (ie, non-amorphous) state. Generally, at least one of the opposite major surfaces of the substrate, in tape-like form, is polycrystalline and non-textured.

According to an aspect of the present invention, a treatment process may begin with a polishing process that includes degreasing, polishing, and rinsing steps. Following polishing, processing may continue with cleaning processes such as high pressure spraying and ultrasonic cleaning, followed by annealing, and ion cleaning, such as by plasma or ion etching. The foregoing treatments generally precede buffer layer deposition, such as by ion beam-assisted deposition (IBAD).

In general, the metal substrate tape cleaning process of the present invention is performed to remove any surface contaminates that may be detrimental to the surface quality of the substrate tape, in an effort to deposit high quality layers on the substrate and achieve a superconducting tape with high critical current density, for example. High pressure rinsing and ultrasonic cleaning may be performed to remove the loosely joined materials that may have accumulated on the metal substrate tape due to, for example, a previous polishing procedure. The annealing process subsequently provides further cleaning of the metal substrate tape to remove any film resulting from any previous polishing procedure, and to remove any organic substances, such as oils left by cleaning solvents used in the previous ultrasonic cleaning process or lubricants used in any prior processing equipment. The annealing process may also heal any surface defects by relaxing the crystalline surface structure. Ion cleaning may be effective to remove surface contaminates remaining from the two previous cleaning processes and to remove any native oxide layer present from the surface of the substrate tape.

The foregoing process may be broadly referred to as polishing and cleaning. Following such processing, superconductor fabrication continues with barrier and buffer layer deposition, superconductor (e.g., HTS) layer deposition, and a shunting/protective layer deposition process described in more detail hereinbelow.

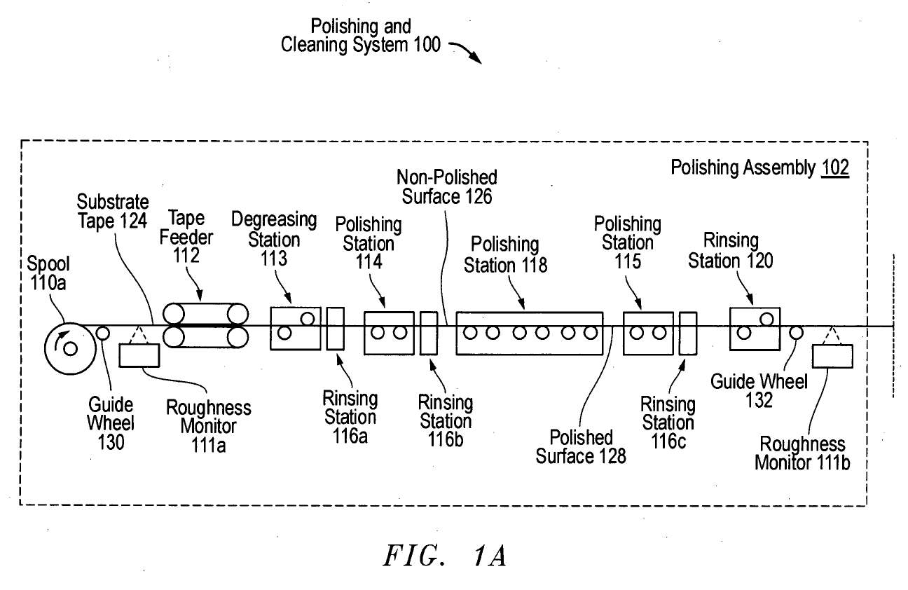

FIGS. 1A and 1B illustrate a polishing and cleaning system 100 for the surface preparation of a substrate tape used in the manufacture of HTS-coated tape. The polishing and cleaning system 100 includes a polishing assembly 102 that performs the substrate tape polishing function, as illustrated in FIG. 1A, and a cleaning assembly 104 that performs a subsequent substrate tape cleaning function, as illustrated in FIG. 1B.

With reference to FIGS. 1A and 1B, the polishing and cleaning system 100 includes multiple instantiations of a spool 110, i.e., a spool 110a (FIG. 1A) and a spool 110b (FIG. 1B). The spool 110a serves as a payout spool located at the entry point of the polishing and cleaning system 100. Upon the spool 110a is wound a length of substrate tape 124 that is formed of metals such as stainless steel or a nickel alloy such as Inconel. The substrate tape 124 has a non-polished surface 126 and a polished surface 128. The substrate tape 124 may experience a deburring process, such as electro-polishing or grinding, prior to usage. Additionally, the substrate tape 124 may experience a mechanical flattening process prior to usage. The substrate tape 124 typically has several meters of “leader” at both ends to aid in handling. Furthermore, to insure a more controlled surface quality of the substrate tape 124, the substrate tape 124 may experience a well-known nickel-plating process, such as an electroplating bath process, that results in fewer surface defects.

The substrate tape 124 is laced through the polishing assembly 102 and the cleaning assembly 104 of the polishing and cleaning system 100 from the spool 10a and wound onto the spool 110b, which serves as a take-up spool, at the exit point of the polishing and cleaning system 100. The diameter and width of the spool 110 may vary depending on the dimensions of the substrate tape 124. Each spool 110 is driven by a torque motor. When installed, the torque exerted by the spool 110a is opposite the torque exerted by the spool 110b to provide the proper tension on the substrate tape 124 as it unwinds from the spool 110a and translates through the polishing and cleaning system 100 and subsequently winds onto the spool 110b.

With reference to FIG. 1A, which illustrates the portion of the polishing and cleaning system 100 that performs the substrate tape polishing function, the polishing assembly 102 further includes a tape feeder 112 that is a set of motor-driven belts that serve as the driving mechanism for translating the substrate tape 124 through the polishing and cleaning system 100. The tape feeder 112 also guides the substrate tape 124 from the spool 110a into a degreasing station 113. The tape feeder 112 provides a controlled rate of translation to allow the proper exposure time of the substrate tape 124 to the polishing and cleaning events that take place within the polishing and cleaning system 100. The pressure exerted on the substrate tape 124 by the belts creates friction to cause the substrate tape 124 to translate through the tape feeder 112 due to the rotation of the belts driven by a stepper motor.

The degreasing station 113 serves as a pre-cleaning station and includes a stainless steel tank containing a set of polishing wheels, one of which makes contact with the non-polished surface 126 of the substrate tape 124, and the other makes contact with the polished surface 128 of the substrate tape 124. The polishing wheels may be soft polishing wheels, such as a Boston Felt soft wheel, having a Shore A hardness in the range of 30 to 40. A motor drives the polishing wheels of the degreasing station 113. Furthermore, the degreasing station 113 includes multiple sprayer assemblies for applying a commercially available degreasing medium. Each sprayer assembly is fed by the source of degreasing medium with a pressure to accomplish the rinsing event, such as in a range of 10 to 200 psi. The degreasing medium is supplied via a conventional pump (not shown). The polishing wheels in combination with applying the degreasing medium serve to scrub and rinse organic contaminants, such as lubricants or edge oil, from the substrate tape 124. The degreasing medium may be drained out of the degreasing station 113, filtered, and recirculated back to the degreasing station 113.

The polishing assembly 102 further includes one or more mechanical polishing stations 114, where each polishing station 114 includes a stainless steel tank containing a pair of polishing wheels that contact the polished surface 128 of the substrate tape 124 in combination with a polishing medium in the form of a slurry. The polishing wheels in the polishing stations 114 may be diamond hard felt polishing wheels, such as manufactured by Boston Felt, with a Shore A hardness above 85, coupled with a slurry polishing medium to effect polishing, such as aluminum oxide (Al₂O₃) or silicon oxide (SiO₂) slurry. Additional polishing stations 114 having finer polishing qualities may be implemented downstream of the polishing station 114, and may utilize a slurry of finer particle size and softer polishing wheels. Generally, each polishing wheel within the polishing stations 114 has an associated pressure device for applying pressure upon the non-polished surface 126 of the substrate tape 124, which, in turn, transfers pressure to the polished surface 128 of the substrate tape 124 against its associated polishing wheel. Each pressure device is typically set within a range of 0 to 300 lbs. per square inch.

In operation, the polishing medium slurry is pumped through a filter into each polishing station 114 with a controlled flow rate of, for example, 1.0 cc per second. Additionally, each polishing station 114 may include misters fed by tap water or de-ionized water. The misters generally create a fog that keeps the substrate tape 124 wet when the polishing and cleaning system 100 is idle or when the user chooses not to activate the polishing function of a given polishing station 114.

The polishing assembly 102 further includes multiple instantiations of a rinsing station 116. More specifically, each polishing station 114, 118, and 115 has an associated downstream rinsing station. FIG. 1A shows, for example, a rinsing station 116a, a rinsing station 116b, and a rinsing station 116c, where each rinsing station 116 includes a stainless steel or plastic tank containing multiple sprayer assemblies for applying pressurized rinsing water to the non-polished surface 126 and the polished surface 128 of the substrate tape 124 for rinsing the degreasing or polishing medium from the substrate tape 124. The sprayer assemblies within each rinsing station 116 are fed by a source of rinsing water, such as tap water or de-ionized water, operating typically in the range of 40 to 350 psi. The rinsing water is supplied via a pump. The rinsing water is delivered to the surfaces of the substrate tape 124 and the spent water is subsequently allowed to drain out of the bottom of each rinsing station 116.

The polishing assembly 102 further includes a polishing station 118 prior to that of the final polishing station, the polishing station 118 including stainless steel tank containing multiple pairs of polishing wheels that contact the polished surface 128 of the substrate tape 124 in combination with a polishing medium in the form of a slurry such as silica or alumina. The polishing wheels in the polishing station 118 may be hard felt polishing wheels having a Shore A hardness in the range of 30 to 85. Each polishing wheel within the polishing station 118 may have an associated pressure device for applying pressure upon the non-polished surface 126 of the substrate tape 124, which, in turn, transfers pressure to the polished surface 128 of the substrate tape 124 against its associated polishing wheel. Each pressure device is typically set within a range of 0 to 300 lbs. per square inch. In one embodiment, the pressure setting within each polishing station 114 using an aluminum oxide slurry is typically around 35 psi.

In operation, the polishing medium slurry, is pumped through a filter into the polishing station 118 with a controlled flow rate of, for example, 1.0 cc per second. The filter may be a commercially available particle filter, designed to limit the particle size range, such as between 0.05 and 50 microns, for example, and thus prevent the scratching of the substrate 124. The pump is typically capable of providing a flow rate of between 17 ml to 1.7 liters per minute. Additionally, the polishing station 118 may include misters fed by tap water or de-ionized water, as described above.

The polishing assembly 102 further includes a final mechanical polishing station 115. The apparatus of the polishing station 15 is generally similar in form and function to the polishing station 114 but is generally configured to provide finer polishing than station 114, by selectively utilizing a finer slurry, a less aggressive slurry (e.g., silicon oxide as the polishing medium rather than alumina), less pressure, and/or varying polishing wheels. Operation of polishing station 115 is generally carried out as described above.

The polishing assembly 102 further includes a rinsing station 120 that serves as a final rinsing station. The rinsing station 120 may be substantially identical to the degreasing station 113, but generally rinses with water rather than a degreasing medium.

Disposed between the spool 110a and the tape feeder 112 is a guide wheel 130. Likewise, disposed between the rinsing station 120 and the cleaning assembly 104 is a guide wheel 132. The guide wheels 130 and 132 are in contact with the polished surface 128 of the substrate tape 124 and assist in supporting and guiding the substrate tape 124 as it translates along the polishing assembly 102. The guide wheels 130 and 132 are formed of a material that is not damaging to the polished surface 128 of the substrate tape 124, such as Teflon or soft rubber.

FIG. 1B illustrates the portion of the polishing and cleaning system 100 that performs the substrate tape cleaning function, using ultrasonic cleaning to break the adhesion between loosely joined materials, such as particles from the polishing medium. FIG. 1B shows the cleaning assembly 104 fed by the substrate tape 124 from the upstream polishing assembly 102. The substrate tape 124 translates through the cleaning assembly 104 via multiple instantiations of a spool 135 and multiple instantiations of an idler 137, for example, a spool 137a through a spool 135m, and an idler 137a through an idler 137f, as shown in FIG. 1B. Finally, the substrate tape 124 is wound upon the spool 110b that serves as the take-up spool for the polishing and cleaning system 100. Since one surface of the substrate tape 124 has experienced the prior polishing process of polishing assembly 102, the arrangement of the spool 137a through the spool 137m and the idler 137a through the idler 137f within the polishing and cleaning system 100 is such that only the non-polished surface 126 of the substrate tape 124 is in contact with the spool 135a through the spool 135m and the idler 137a through the idler 137f. The dimensions of the spool 135a through the spool 135m and the idler 137a through the idler 137f are in accordance with the dimensions of the substrate tape 124 translating through the polishing and cleaning system 100. The idler 137a through the idler 137f are designed to provide a change in direction of the substrate tape 124 by shifting the plane along which the substrate tape 124 translates, as illustrated by Detail A in FIG. 1C.

With continuing reference to FIG. 1B, the cleaning assembly 104 further includes one or more instantiations of an ultrasonic cleaner 144 and multiple instantiations of a rinsing station 140. For example, the cleaning assembly 104 includes an ultrasonic cleaner 144a followed by an associated rinsing station 140a, and an ultrasonic cleaner 144b followed by an associated rinsing station 140b, as shown in FIG. 1B. However, the polishing and cleaning system 100 is not limited to two instantiations of the ultrasonic cleaner 144; several instantiations of the ultrasonic cleaner 144 may be implemented within the polishing and cleaning system 100. Additionally, the polishing and cleaning system 100 includes an ultrasonic cleaner 146. The ultrasonic cleaner 144a, the ultrasonic cleaner 144b, and the ultrasonic cleaner 146 are ultrasonic cleaning devices that perform a well-known immersion cleaning event upon the substrate tape 124 using high-energy waves. The waves are mechanical waves, generally sound waves, such as ultrasound waves having a frequency not less than about 20 kHz, or not less than about 100 kHz, or even 200 kHz.

The spool 135a and the spool 135b are disposed such that the substrate tape 124 is bathed in a solvent 143 within the ultrasonic cleaner 144a. Likewise, the spool 135e and the spool 135f are disposed such that the substrate tape 124 is bathed in a solvent 145 within the ultrasonic cleaner 144b. Since the substrate tape 124 has experienced a prior polishing process, the solvent 143 and the solvent 145 may be, for example, a surfactant such as a detergent mixed with water that lowers the surface tension of the substrate tape 124; a specific chemical such as an acid that reacts with and removes the polishing medium; a chemical to reduce oil or other organic contamination present on the substrate tape 124; or a mixture of the these solvents.

Additionally, downstream of the ultrasonic cleaner 144a and the ultrasonic cleaner 144b, the substrate tape 124 experiences a rinsing event via the rinsing station 140a disposed between the spool 135c and the spool 135d and the rinsing station 140b disposed between the spool 135g and the spool 135h, respectively, as shown in FIG. 1A. The rinsing station 140 is, for example, a stainless steel tank having an entry and exit slot through which the substrate tape 124 is fed. The rinsing station 140a and the rinsing station 140b are fed by a source of rinsing water, such as de-ionized water or standard tap water, at a pressure typically in the range of 40 to 70 psi, which is commonly available city pressure. The rinsing water is delivered to the surfaces of the substrate tape 124 via a set of sprayer assemblies, and the spent water is subsequently allowed to drain away. Inserted in the entry slot and the exit slot may be a squeegee (not shown) formed of felt for removing excess water from the substrate tape 124 as it passes therethrough.

Additionally, the spool 135j and the spool 135k are disposed such that the substrate tape 124 is bathed in a solvent 147 within the ultrasonic cleaner 146. Since the ultrasonic cleaner 146 is the final ultrasonic cleaning event within the polishing and cleaning system 100, the solvent 147 is typically de-ionized water.

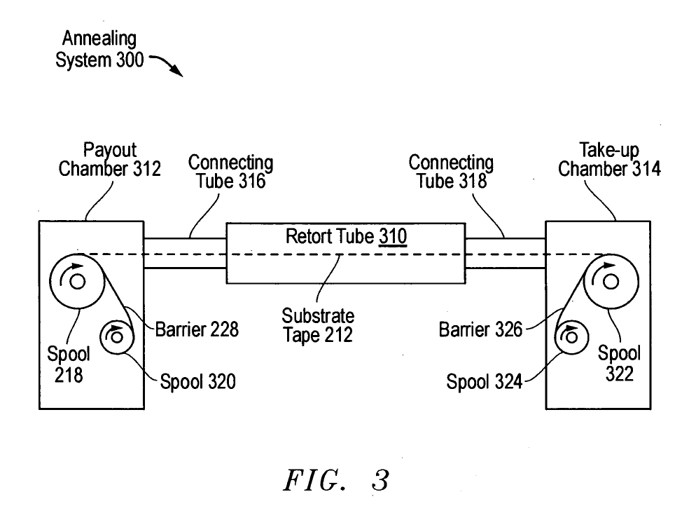

The substrate tape 124 is subsequently fed through a rinsing station 140c located between the ultrasonic cleaner 146 and a dryer 162. The rinsing station 140c is fed by a source of de-ionized water at a pressure typically in the range of 40 to 350 psi. The rinsing water is delivered to the surfaces of the substrate tape 124 via a set of sprayer assemblies, such as the sprayer assembly 430 as described in FIG. 4A, and the spent water is subsequently allowed to drain away.

Finally, the substrate tape 124 is fed through the dryer 162, which is disposed between the rinsing station 140c and the spool 135k and the idler 137e, as shown in FIG. 1A.

The dryer 162 is located near the back end of the cleaning assembly 104 downstream of all ultrasonic cleaners for the purpose of drying the substrate tape 124 prior to winding onto the spool 110b. The dryer 162 is, for example, a well-known “air knife” that provides a non-contact method of removing unwanted liquid or particles from an object by utilizing low pressure/high velocity air. Alternatively, the dryer 162 is an enclosed chamber through which the substrate tape 124 is exposed to blowing gas, such as carbon oxide, clean air, or nitrogen. In this case, the dryer 162 would include a gas source inlet and an exhaust outlet. As a further alternative, the dryer 162 is a well-known infrared (1R) heater.

The cleaning and/or polishing operation may be carried out in a stop-and-go (stepping) process, or by a continuous cleaning process. Translation is typically carried out at a ratio of at least 2″/min., such as at least 10, 20, 50, or 100″/min.

The polishing and cleaning system 100 may include one or more instantiations of a roughness monitor 111 disposed at different locations throughout the polishing and cleaning system 100 and directed at the polished surface 128 of the substrate tape 124. For instance, a roughness monitor 111a is disposed between the guide wheel 130 and the tape feeder 112 of polishing assembly 102, a roughness monitor 111b is disposed between the guide wheel 132 of the polishing assembly 102 and the idler 137a of the cleaning assembly 104, and a roughness monitor 111c is disposed between the spool 135m and the spool 110b of the cleaning assembly 104. Each roughness monitor 111 provides a quality check mechanism at its respective location of the polishing and cleaning system 100. Each roughness monitor 111 is mounted on a three-axis adjustable stage, such that its position relative to the polished surface 128 of the substrate tape 124 may be adjusted. The distance between the substrate tape 124 and each roughness monitor 111 is set appropriately for measuring roughness to the required accuracy. The monitors may be embodied as optical surface roughness measurement gages, such a LASER^{CHECK} device manufactured by Optical Dimensions LLC, which is designed to measure the surface roughness over which it passes. In the case of the polishing and cleaning system 100, each roughness monitor 111 provides an average surface roughness along the width of the polished surface 128 of the substrate tape 124. Each roughness monitor 111 spans a segment of the width of the tape, such as 2-20 mm, or 3-6 mm, for example.

With reference to FIGS. 1A and 1B, the degreasing station 113, each polishing station 114, each rinsing station 116, the polishing station 118, the rinsing station 120, and each rinsing station 140 has within its respective tank an entry slot and an exit slot, through which the substrate tape 124 may translate. Inserted in each entry slot and exit slot is a squeegee formed of felt for removing excess fluids from the substrate tape 124 as it passes through each respective tank.

The throughput of the polishing and cleaning system 100 is determined by the translation rate of the substrate tape 124, as mentioned above.

The following Tables 1 through 11 illustrate useful control parameters of individual stations.

TABLE 1
Degreasing station 113 control parameters
Degreasing station 113

| | Range |
|---|---|
| Degreasing solution delivery pressure | 40 to 70 psi |
| Degreasing solution filtering requirement | 0.05 to 10 microns |
| Solution incident angle to tape surface | 45 to 90 degrees against the |
| | direction of tape travel |
| Polishing wheel Shore A hardness | Soft: 30 to 40 |
| Polishing wheel speed | 1500 to 3600 rpm |
| Substrate tape translation rate | 2 to 50 inches/minute |

TABLE 2A
First polishing station 114 control parameters
First polishing station 114

| | Range |
|---|---|
| Polishing medium | Aluminum oxide slurry, |
| | silicon oxide slurry, |
| | zirconium oxide slurry |
| Polishing medium particle size | 0.05 to 15 microns, 1.0 microns |
| Polishing medium flow rate | 17 ml to 1.7 liters/minute, 1.0 |
| | to 50 cc/minute |
| Polishing medium filtering | 0.05 to 50 microns |
| requirement | |
| Polishing wheel Shore A | Diamond hard: 85 or above |
| hardness | |
| Polishing wheel speed | 1500 to 3600 rpm, 1500 rpm |
| Pressure device setting | 0 to 300 psi, 20 to 35 psi |
| Substrate tape translation rate | 2 to 50 inches/minute |

TABLE 2B
Optional second polishing station 114 control parameters
Optional second polishing station 114

| | Range |
|---|---|
| Polishing medium | Aluminum oxide slurry, |
| | silicon oxide slurry, |
| | zirconium oxide slurry |
| Polishing medium particle size | 0.05 to 15 microns, 0.3 microns |
| Polishing medium flow rate | 17 ml to 1.7 liters/minute, 1.0 |
| | to 50 cc/minute |
| Polishing medium filtering | 0.05 to 50 microns |
| requirement | |
| Polishing wheel Shore A | Hard: 55 to 65 |
| hardness | |
| Polishing wheel speed | 1500 to 3600 rpm, 1500 rpm |
| Pressure device setting | 0 to 300 psi, 20 to 35 psi |
| Substrate tape translation rate | 2 to 50 inches/minute |

TABLE 2C
Optional third polishing station 114 control parameters
Optional third polishing station 114

| | Range |
|---|---|
| Polishing medium | Aluminum oxide slurry, |
| | silicon oxide slurry, |
| | zirconium oxide slurry |
| Polishing medium particle size | 0.05 to 15 microns, 0.3 microns |
| Polishing medium flow rate | 17 ml to 1.7 liters/minute, 1.0 |
| | to 50 cc/minute |
| Polishing medium filtering requirement | 0.05 to 50 microns |
| Polishing wheel Shore A hardness | Hard: 55 to 65 |
| Polishing wheel speed | 1500 to 3600 rpm, 1500 rpm |
| Pressure device setting | 0 to 300 psi, 20 to 35 psi |
| Substrate tape translation rate | 2 to 50 inches/minute |

TABLE 3
Polishing station 118 control parameters
Polishing station 118

| | Range |
|---|---|
| Polishing medium | Aluminum oxide slurry, |
| | silicon oxide slurry, |
| | zirconium oxide slurry |
| Polishing medium particle size | ≦0.05 microns, 0.05 micros |
| Polishing medium flow rate | 17 ml to 1.7 liters/minute, 1.0 |
| | to 50 cc/minute |
| Polishing medium filtering requirement | 0.05 to 50 microns |
| Polishing wheel Shore A hardness | Hard: 55 to 65 |
| Polishing wheel speed | 1500 to 3600 rpm, 1500 rpm |
| Pressure device setting | 0 to 300 psi, 20 to 35 psi |
| Substrate tape translation rate | 2 to 50 inches/minute |

TABLE 4
Polishing station 115 control parameters
Polishing station 115

| | Range |
|---|---|
| Polishing medium | Aluminum oxide slurry, |
| | silicon oxide slurry, |
| | zirconium oxide slurry |
| Polishing medium particle size | 0.3 to 1.0 microns, 0.05 microns |
| Polishing medium flow rate | 17 ml to 1.7 liters/minute, 1.0 |
| | to 50 cc/minutes |
| Polishing medium filtering requirement | 0.05 to 50 microns |
| Polishing wheel Shore A hardness | Hard: 55 to 65 |
| Polishing wheel speed | 1500 to 3600 rpm, 1500 rpm |
| Pressure device setting | 0 to 300 psi, 15 to 25 psi |
| Substrate tape translation rate | 2 to 50 inches/minute |

TABLE 5
Rinsing stations 116 control parameters
All rinsing stations 116

| | Range |
|---|---|
| Rinsing solution | Tap water, de-ionized water |
| Rinsing solution delivery pressure | 40 to 350 psi |
| Rinsing solution incident | 45 to 90 degrees against the |
| angle to tape surface | direction of tape travel |
| Substrate tape translation rate | 2 to 50 inches/minute |

TABLE 6
Rinsing station 120 control parameters
Rinsing station 120

| | Range |
|---|---|
| Rinsing solution | Tap water, de-ionized water |
| Rinsing solution delivery pressure | 40 to 350 psi |
| Rinsing solution incident | 45 to 90 degrees against the |
| angle to tape surface | direction of tape travel |
| Substrate tape translation rate | 2 to 50 inches/minute |

TABLE 7
Rinsing stations 140a, 140b, and 140c control parameters
Rinsing stations 140a, 140b, and 140c

| | Range |
|---|---|
| Rinsing solution | Tap water, de-ionized water |
| Rinsing solution delivery pressure | 40 to 70 psi |
| Rinsing solution incident | 45 to 90 degrees against the |
| angle to tape surface | direction of tape travel |
| Substrate tape translation rate | 2 to 50 inches/minute |

TABLE 8
Ultrasonic cleaner 144a control parameters
Ultrasonic cleaner 144a

| | Range |
|---|---|
| Power level | 250 to 3000 Watts, 1500 Watts |
| Ultrasonic frequency | 25 KHz to 1 MHz, 25 to 170 KHz |
| Cleaning Solvent (Solvent 143) | Surfactant, such as a detergent |
| | mixed with water |
| Substrate tape translation rate | 2 to 50 inches/minute |

TABLE 9
Ultrasonic cleaner 144b control parameters
Ultrasonic cleaner 144b

| | Range |
|---|---|
| Power level | 250 to 3000 Watts, 1500 |
| | Watts |
| Ultrasonic frequency | 25 KHz to 1 MHz, 750 KHz |
| Cleaning Solvent (Solvent 145) | Surfactant, such as a detergent |
| | mixed with water, tap water, |
| | de-ionized water |
| Substrate tape translation rate | 2 to 50 inches/minute |

TABLE 10
Ultrasonic cleaner 146 control parameters
Ultrasonic cleaner 146

| | Range |
|---|---|
| Power level | 250 to 3000 Watts, 1500 |
| | Watts |
| Ultrasonic frequency | 25 KHz to 1 MHz, 750 |
| | KHz |
| Cleaning Solvent (Solvent 147) | Tap water, de-ionized |
| | water |
| Substrate tape translation | 2 to 50 inches/minute |
| rate | |

TABLE 11
Dryer 162 control parameters
Dryer 162

| | Range |
|---|---|
| Dryer type | Air knife; blowing gas, |
| | such as carbon oxide, |
| | clean air, or nitrogen; |
| | infrared heater |
| Power level (pressure) | 40 to 120 psi, 80 psi |
| Substrate tape translation rate | 2 to 50 inches/minute |

In operation, and with continuing reference to FIGS. 1A and 1B, the substrate tape 124 is laced through all elements of the polishing and cleaning system 100, which are arranged in a line along the axis of the substrate tape 124 formed between the spool 110a and the spool 10b. Subsequently, all active devices within the polishing and cleaning system 100, such as the pumps and motors associated with the various stations, are activated. As a result, the substrate tape 124 first experiences the degreasing event of the degreasing station 113, then immediately experiences the rinsing event of the rinsing station 116a. Subsequently, the substrate tape 124 experiences the polishing event of any subsequent polishing stations 114 with their associated rinsing event. The first polishing station 114 provides the most aggressive polishing event within the polishing and cleaning system 100. Subsequent polishing stations 114 provide a less aggressive polishing event than the first polishing station 114. Subsequently, the substrate tape 124 experiences the polishing event of the polishing station 118. The polishing event of the polishing station 118 may be yet less aggressive than the polishing event of the upstream polishing stations 114. Subsequently, the substrate tape 124 experiences the polishing event of the polishing station 115, then experiences the rinsing event of the rinsing station 120. The polishing event of the polishing station 118 is the least aggressive polishing event within the polishing and cleaning system 100. The substrate tape 124 may be prevented from drying in the period of time that it is translating between stations, thus the physical distance between stations should be set accordingly to minimize this time period, typically limited to not more than 1 minute, such as less than 30 seconds. Optionally, misters are present within and between the polishing stations.

Having experienced multiple polishing and rinsing events in the polishing assembly 102 of the polishing and cleaning system 100, the substrate tape 124 translates into the cleaning assembly 104 and experiences the cleaning event of the ultrasonic cleaner 144a, then experiences the rinsing event of the rinsing station 140a. Subsequently, the substrate tape 124 experiences the cleaning event of the ultrasonic cleaner 144b, then experiences the rinsing event of the rinsing station 140b. Subsequently, the substrate tape 124 experiences the cleaning event of the ultrasonic cleaner 146, then experiences the rinsing event of the rinsing station 140c. Subsequently, the substrate tape 124 experiences the drying event of the dryer 162 and is then wound upon the spool 110b along with the barrier 160 from the spool 155. Concurrently to the polishing and cleaning events, the polished surface 128 of the substrate tape 124 is monitored using the roughness monitors 111a, 111b, and 111c to verify the progressive improvement of the polished surface 128 smoothness and cleanliness.

The polishing and cleaning system 100 may provide constant misting to the substrate tape 124 along its entire length. This may be desirable in order to prevent the substrate tape 124 from drying during system idle time or at the portions of the substrate tape 124 translating between the elements of the polishing and cleaning system 100. In addition, the cleaning assembly 104 within the polishing and cleaning system 100 may be enclosed in order to protect the substrate tape 124 and the elements of the cleaning assembly 104 from any airborne particles or debris originating from the polishing assembly 102. Lastly, the entire polishing and cleaning system 100 may be housed in a clean room environment that provides positive air pressure and/or laminar air flow in order to keep contaminating particles from entering the chamber and depositing on to the polished surface.

The distance between the various polishing, rinsing, and cleaning stations within the polishing and cleaning system 100 may be sufficiently short so that the substrate tape 124 does not dry out while translating between stations. Alternatively, misters may be inserted between stations to ensure that the substrate tape 124 is continuously wet.

Alternatively, multiple steam-cleaning stations may be inserted in the cleaning assembly 104. For example, a first steam-cleaning station immediately downstream of the ultrasonic cleaner 144a, a second steam-cleaning station immediately downstream of the ultrasonic cleaner 144b, and a third steam-cleaning station immediately downstream of the ultrasonic cleaner 146. These additional steam-cleaning stations keep the substrate tape 124 from drying.

In summary, the substrate tape 124 experiences, via progressive stages, first a rough, then a medium, then a fine polishing event in combination with a respective rinsing event as it translates through the elements of the polishing assembly 102, where the control parameters of these elements are optimized according to Tables 1 through 6. Any polishing medium residue remaining on the substrate tape 124 is then further washed away via multiple cleaning events provided by the elements within the cleaning assembly 104. In this way, the substrate tape 124 achieves a surface smoothness and cleanliness that is suitable for the subsequent deposition of a buffer layer.

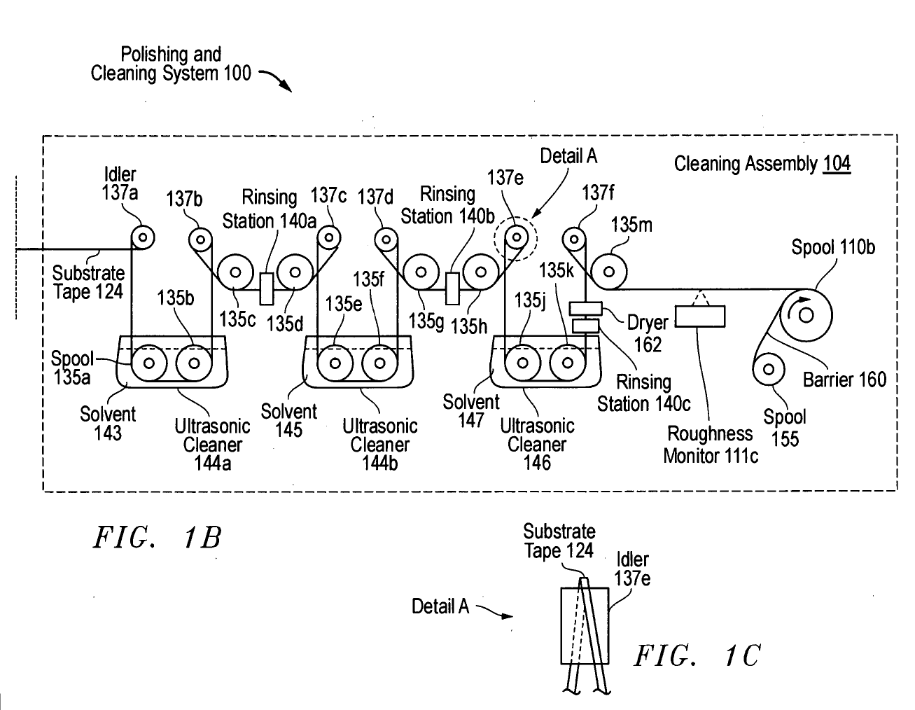

FIG. 2 illustrates another embodiment of a polishing and cleaning system, system 200 that is similar to system 100, but takes advantage of an in-line or linear ultrasonic cleaner 244 rather than the configuration shown in FIG. 1B. The in-line ultrasonic cleaner is advantageous in that it minimizes contact between the substrate tape 124 and rollers or routing spools, such as by eliminating idlers 137. The ultrasonic cleaner 244 includes a central cleaning chamber 246, in which a solvent medium is contained for transfer of ultrasound waves to the substrate tape. Outer chambers 248 are kept at a fluid level above the central cleaning chamber 246 to maintain the solvent in a full state. Additional outer chambers may be utilized, to help minimize the rate of fluid loss from the central cleaning chamber 246, and may include an outermost chamber that is dry, and intended only for collection of lost fluid that may be recycled to the central cleaning chamber and/or the outer chambers. The substrate tape passes into the outer chambers through an opening that is fluid sealed through use of a resilient seal, such as in the form of a wiper.

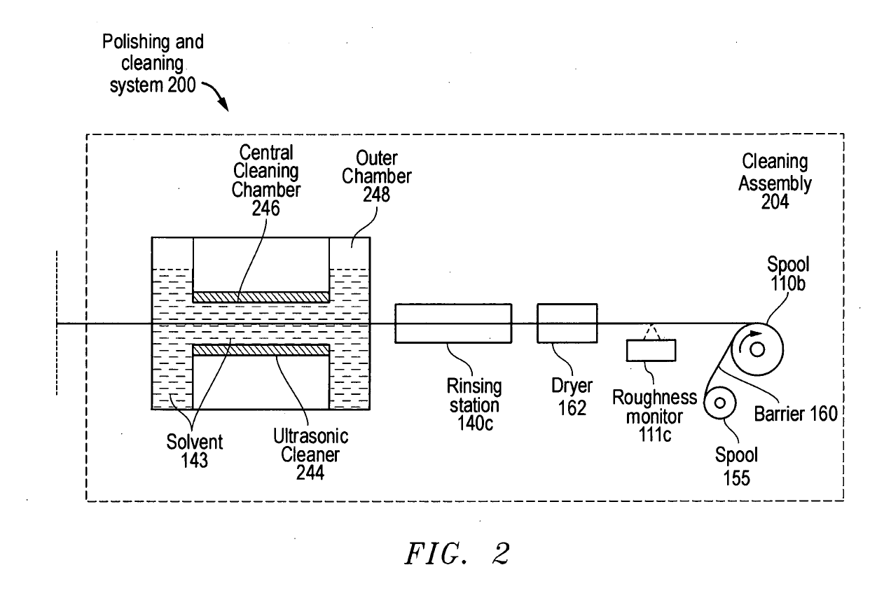

FIG. 3 illustrates an annealing system 300 for further treating the tape, such as after polishing and ultrasound cleaning. The annealing action of the annealing system 300 may relax the crystalline structure of the substrate tape 212 to a less stressed condition, thereby healing the surface defects on the substrate tape 212, such as porosity caused by the polishing process and metallurgical defects in the crystal structure. Additionally, the annealing system 300 serves to volatilize organic contamination on the surface of the substrate tape 212.

FIG. 3 illustrates a vacuum tight annealing system 300 that includes a retort tube 310 arranged between a payout chamber 312 and a take-up chamber 314. The retort tube 310 is a water-cooled annealing furnace that performs an annealing event upon the substrate tape 212. The retort tube 310 may include three heating zones to produce an even temperature profile throughout the annealing process. The retort tube 310 is vacuum-tight, thereby preventing any oxidation from occurring on the substrate tape 212 as it is heated.

The payout chamber 312, within which is mounted the spool 218 having the substrate tape 212 with its barrier 228 wound upon it, is mechanically connected to the retort tube 310 via a hollow connecting tube 316. Likewise, the take-up chamber 314, within which is mounted a spool 322 for receiving the substrate tape 212, is mechanically connected to the retort tube 310 via a hollow connecting tube 318. Disposed within the connecting tube 318 is a cooling jacket that provides controlled water-cooling to the substrate tape 212 as it exits the retort tube 310 to be subsequently wound onto the spool 322. Disposed at the interface of the connecting tube 316 and the retort tube 310 is a restrictor (not shown) to reduce the heat transmission from the retort tube 310 to the payout chamber 312. Likewise, disposed at the interface of the connecting tube 318 and the retort tube 310 is a restrictor to reduce the heat transmission from the retort tube 310 to the take-up chamber 314.

In operation and with continuing reference to FIG. 3, the spool 218, having the substrate tape 212 with its barrier 228 wound upon it, is mounted inside the payout chamber 312. The substrate tape 212 is laced through the connecting tube 316, then through the retort tube 310, then through the connecting tube 318, and subsequently wound upon the spool 322 within the take-up chamber 314. As the substrate tape 212 is unwound from the spool 218 the barrier 228 is received by a spool 320 also mounted within the payout chamber 312. In opposite fashion, a barrier 326, which is identical to the barrier 228, is unwound from a spool 324 mounted within the take-up chamber 314 and, along with the substrate tape 212, is wound upon the spool 322, thereby providing a protective interleaf between adjacent layers of substrate tape 212 as wound. Having laced the substrate tape 212 through the annealing system 300, the annealing system 300 is sealed.

Oxygen is purged from the annealing system 300 to form a vacuum, such as at a pressure of between about 10⁻² and 10⁻⁵ Torr, such as to 10⁻⁴ Torr. A narrower range is about 2×10⁻³ Torr and 5×10⁻³ Torr. The retort tube 310 is then filled with a forming gas, a gas mixture for conditioning metal without oxidizing its surface. For example, a non-reactive gas or inert gas may be used or a reducing environment may be used, such as a mixture of 96% argon and 4% hydrogen. This sequence may be repeated to purge oxygen from the annealing system 300 so that oxidation of the substrate tape 212 is prevented.

The retort tube 310 is ramped up to, for example, a temperature in the range of about 400 to 1200° C., such as about 500 to 1000° C., or 600 to 900° C. The motor driven spools 218, 320, 322, and 324 are activated to provide a translation speed such that sections of the substrate tape 212 were heated, for example, for about 1 minute to 10 hours, such as 1 minute to 1 hour, 2 minutes to 30 minutes. One working example had had an exposure time of about ten minutes within the retort tube 310.

FIG. 4 illustrates an ion cleaning system, notably a plasma cleaning system 400 that may be implemented downstream in the process flow from the annealing step, which generally follows the polishing and ultrasound cleaning operations described above. The plasma cleaning system 400 performs a cleaning event to remove any surface contaminates and oxidization remaining from these previous cleaning processes.

The plasma cleaning system 400 includes a payout chamber 410 that is a vacuum chamber suitable to house the payout spooling system and to house the elements needed to perform a plasma cleaning event that accelerates ionized gas toward a target. The vacuum pressure within the payout chamber 410 is typically between 10⁻² and 10⁻⁵ Torr, such as 10⁻³ and 10⁻⁴ Torr. The payout chamber 410 is coupled to a downstream chamber, for example, a deposition chamber 412, as shown in FIG. 4, that houses a film deposition process, such as an IBAD process. The payout chamber 410 and the deposition chamber 412 are coupled by a connector 414 that is a differential connector to isolate the process pressures between the two chambers.

Mounted within the payout chamber 410 is the spool 322 having the substrate tape 212 and the barrier 326 wound upon it. The substrate tape 212 is fed through the connector 414 and into the deposition chamber 412, all the while the barrier 326 is received by a spool 416. Also housed within the payout chamber 410 is a plasma source 418 fed by a gas source 420. The plasma source 418 is an ion gun, such as an anode layer ion gun. The gas source 420 is fed by a supply of oxygen free gas suitable for plasma reaction, such as argon.

In operation, the plasma source 418 of the plasma cleaning system 400 is activated, thereby producing a plasma reaction and forming a plasma region 422 that is directed toward the substrate tape 212 and thereby exposes the substrate tape 212 to the plasma cleaning event. As a result, the plasma cleaning system 400 removes residual organic material left by the cleaning events of the ultrasonic cleaning system 200 and/or the annealing system 300 on the surface of the substrate tape 212. Furthermore, the plasma cleaning system 400 removes native oxide layer present on the surface of the substrate tape 212 due to exposure of the substrate tape 212 to oxygen during the cleaning events of the ultrasonic cleaning system 200 and/or the annealing system 300. Removal of the native oxygen layer generally improves the surface adhesion characteristics of the substrate tape 212 for downstream film deposition processes.

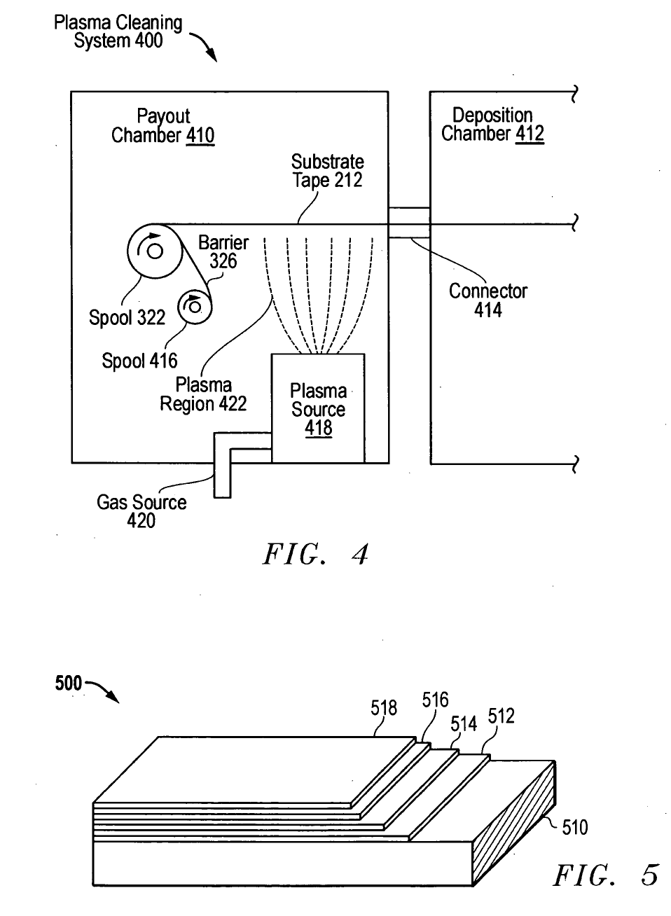

Noteworthy, the above processing of the substrate is typically carried out in uncoated form. That is, the substrate in the form of a high dimension ratio alloy tape subjected to processing including polishing, cleaning annealing, ion treatment, is generally a virgin substrate, not yet subjected to layering to form the general structure shown in FIG. 5 below. As such, at least the opposite major surface intended to be subjected to downstream deposition processes is exposed to polishing, cleaning, annealing, and/or ion treatment. The major surface is typically non-amorphous and polycrystalline, in which the crystals are generally randomly ordered such that the surface is non-textured.

Turning to FIG. 5, the general layered structure of a superconductor according to an embodiment of the present invention is depicted. The superconductor article 500 includes a substrate 510, a buffer layer 512 overlying the substrate 510, a superconductor layer 514, followed by a capping layer 516, typically a noble metal layer, and a stabilizer layer 518, typically a non-noble metal.

Turning to the buffer layer 512, the buffer layer may be a single layer, or more commonly, be made up of several films. Most typically, the buffer layer includes a biaxially textured film, having a crystalline texture that is generally aligned along crystal axes both in-plane and out-of-plane of the film. Such biaxial texturing may be accomplished by IBAD. As is understood in the art, IBAD is acronym that stands for ion beam assisted deposition, a technique that may be advantageously utilized to form a suitably textured buffer layer for subsequent formation of an superconductor layer having desirable crystallographic orientation for superior superconducting properties. Magnesium oxide is a typical material of choice for the IBAD film, and may be on the order or 50 to 500 Angstroms, such as 50 to 200 Angstroms. Generally, the IBAD film has a rock-salt like crystal structure, as defined and described in U.S. Pat. No. 6,190,752, incorporated herein by reference.

The buffer layer may include additional films, such as a barrier film provided to directly contact and be placed in between an IBAD film and the substrate. In this regard, the barrier film may advantageously be formed of an oxide, such as yttria, and functions to isolate the substrate from the IBAD film. A barrier film may also be formed of non-oxides such as silicon nitride and titanium nitride. Suitable techniques for deposition of a barrier film include chemical vapor deposition and physical vapor deposition including sputtering. Typical thicknesses of the barrier film may be within a range of about 100-200 angstroms. Still further, the buffer layer may also include an epitaxially grown film, formed over the IBAD film. In this context, the epitaxially grown film is effective to increase the thickness of the buffer layer, and may desirably be made principally of the same material utilized for the IBAD layer such as MgO.

In embodiments utilizing an MgO-based IBAD film and/or epitaxial film, a lattice mismatch between the MgO material and the material of the superconductor layer exists. Accordingly, the buffer layer may further include another buffer film, this one in particular implemented to reduce a mismatch in lattice constants between the superconductor layer and the underlying IBAD film and/or epitaxial film. This buffer film may be formed of materials such as YSZ (yttria-stabilized zirconia) strontium ruthenate, lanthanum manganate, and generally, perovskite-structured ceramic materials. The buffer film may be deposited by various physical vapor deposition techniques.

While the foregoing has principally focused on implementation of a biaxially textured film in the buffer stack (layer) by a texturing process such as IBAD, alternatively, the substrate surface itself may be biaxially textured. In this case, the buffer layer is generally epitaxially grown on the textured substrate so as to preserve biaxial texturing in the buffer layer. One process for forming a biaxially textured substrate is the process known in the art as RABiTS (roll assisted biaxially textured substrates), generally understood in the art.

The superconductor layer 514, typically in the form of a high-temperature superconductor (HTS) layer, is typically chosen from any of the high-temperature superconducting materials that exhibit superconducting properties above the temperature of liquid nitrogen, 77K. Such materials may include, for example, YBa₂Cu₃O₇₋ₓ, Bi₂Sr₂Ca₂Cu₃O_{10+y}, Ti₂Ba₂Ca₂Cu₃O_{10+y}, and HgBa₂ Ca₂Cu₃O_{8+y}. One class of materials includes REBa₂Cu₃O₇₋ₓ, wherein RE is a rare earth element. Of the foregoing, YBa₂Cu₃O₇₋ₓ, also generally referred to as YBCO, may be advantageously utilized. The superconductor layer 514 may be formed by any one of various techniques, including thick and thin film forming techniques. Preferably, a thin film physical vapor deposition technique such as pulsed laser deposition (PLD) can be used for a high deposition rates, or a chemical vapor deposition technique can be used for lower cost and larger surface area deposition. Typically, the superconductor layer has a thickness on the order of about 1 to about 30 microns, most typically about 2 to about 20 microns, such as about 2 to about 10 microns, in order to get desirable amperage ratings associated with the superconductor layer 514.

The capping layer 516 and the stabilizer layer 518 are generally implemented for electrical stabilization, to aid in prevention of superconductor burnout in practical use. More particularly, layers 516 and 518 aid in continued flow of electrical charges along the superconductor in cases where cooling fails or the critical current density is exceeded, and the superconductor layer moves from the superconducting state and becomes resistive. Typically, a noble metal is utilized for capping layer 516 to prevent unwanted interaction between the stabilizer layer(s) and the superconductor layer 514. Typical noble metals include gold, silver, platinum, and palladium. Silver is typically used due to its cost and general accessibility. The capping layer 516 is typically made to be thick enough to prevent unwanted diffusion of the components from the stabilizer layer 518 into the superconductor layer 514, but is made to be generally thin for cost reasons (raw material and processing costs). Typical thicknesses of the capping layer 516 range within about 0.1 to about 10.0 microns, such as 0.5 to about 5.0 microns. Various techniques may be used for deposition of the capping layer 516, including physical vapor deposition, such as DC magnetron sputtering.

The stabilizer layer 518 is generally incorporated to overlie the superconductor layer 514, and in particular, overlie and directly contact the capping layer 516 in the particular embodiment shown in FIG. 5. The stabilizer layer 518 functions as a protection/shunt layer to enhance stability against harsh environmental conditions and superconductivity quench. The layer is generally dense and thermally and electrically conductive, and functions to bypass electrical current in case of failure in the superconducting layer. It may be formed by any one of various thick and thin film forming techniques, such as by laminating a pre-formed copper strip onto the superconducting tape, by using an intermediary bonding material such as a solder or flux. Other techniques have focused on physical vapor deposition, typically, sputtering, electroless plating, and electroplating. In this regard, the capping layer 516 may function as a seed layer for deposition of copper thereon.

After completion of the superconductive tape, it may be utilized for from various devices, including commercial or industrial power equipment, such as power distribution or transmission power cables, power transformers, power generators, electric motors, fault current interrupters, and similar devices.

The above-disclosed subject matter is to be construed as illustrative and not restrictive, and the appended claims are intended to cover all such modifications, enhancements, and other embodiments that fall within the scope of the present invention. Thus, to the maximum extent allowed by law, the scope of the present invention is to be determined by the broadest permissible interpretation of the following claims and their equivalents and shall not be restricted or limited by the foregoing detailed description.

1. A method of forming a superconductive device, comprising:
cleaning a substrate having a dimension ratio of not less than about 10², the cleaning including immersing the substrate in a fluid medium and subjecting the substrate to mechanical waves in the fluid medium; and
depositing a superconductor layer to overlie the substrate.

2. The method of claim 1, wherein the fluid medium comprises water.

3. The method of claim 1, wherein the mechanical waves comprise sound waves.

4. The method of claim 3, wherein the sound waves are ultrasound waves, having a frequency not less than about 20 kHz.

5. The method of claim 4, wherein the sound waves have a frequency not less than about 100 kHz.

6. The method of claim 4, wherein the sound waves have a frequency not less than about 200 kHz.

7. The method of claim 1, wherein the substrate is translated through the fluid medium in a reel-to-reel process.

8. The method of claim 7, wherein the substrate is translated continuously through the fluid medium while subjecting the substrate to the mechanical waves.

9. The method of claim 1, wherein the substrate is translated through the fluid medium at a rate of at least 2 inches/minute.

10. The method of claim 1, wherein the substrate is translated through the fluid medium at a rate of at least 10 inches/minute.

11. The method of claim 1, further comprising a step of polishing the substrate prior to cleaning.

12. The method of claim 11, wherein polishing includes reducing a surface roughness of at least one side of the substrate through a series of successive polishing operations.

13. The method of claim 11, wherein polishing is carried out by contacting the substrate with an abrasive slurry, and applying a force against the substrate to effect material removal.

14. The method of claim 1, further comprising a step of executing a high pressure rinse prior to cleaning.

15. The method of claim 1, further comprising exposing the substrate to an annealing step after cleaning.

16. The method of claim 15, wherein annealing is carried out at a temperature of at least 400° C.

17. The method of claim 15, wherein annealing is carried out in a non-oxidizing environment.

18. The method of claim 17, wherein the non-oxidizing environment is a reducing environment, containing a reducing gaseous component.

19. The method of claim 17, wherein the non-oxidizing environment comprises an non-reactive gas.

20. The method of claim 15, wherein the annealing is effective to reduce defects along a surface of the substrate.

21. The method of claim 15, wherein the annealing is effective to remove impurities along a surface of the substrate.

22. The method of claim 1, further comprising a step of plasma treatment after cleaning.

23. The method of claim 22, wherein the plasma treatment is effective to remove impurities along a surface of the substrate.

24. The method of claim 1, further comprising depositing a buffer layer overlying the substrate, prior to depositing the superconductor layer.

25. The method of claim 24, wherein the buffer layer includes at least one film that is biaxially textured.

26. The method of claim 25, wherein the biaxially textured layer film is formed by an IBAD process.

27. The method of claim 1, wherein the superconductor layer has a Tc not less than about 77K.

28. The method of claim 27, wherein the superconductor layer comprises YBCO.

29. The method of claim 1, further comprising depositing a stabilizer layer overlying the superconductor layer.

30. The method of claim 1, wherein the superconductive device is a superconductive tape.

31. The method of claim 1, wherein the superconductive device is an electric power component incorporating a superconductive tape comprising said substrate and superconductor layer.

32. The method of claim 1, wherein the substrate has first and second opposite major surfaces, at least the first opposite major surface being polycrystalline and randomly textured, the first opposite major surface being directly exposed to the cleaning medium during cleaning.

33. The method of claim 1, wherein the superconductor layer overlies the first major surface.

34. A method of forming a superconductive device, comprising:
annealing a substrate having a dimension ratio of not less than about 1; and
depositing a superconductor layer to overlie the substrate.

35. The method of claim 34, wherein the substrate is annealed in an uncoated form, free of deposited layers.

36. A method of forming a superconductive device, comprising:
providing a substrate having a dimension ratio of not less than about 10² and having first and second opposite major surfaces, at least the first opposite major surface being polycrystalline and randomly textured;
subjecting the first opposite major surface to ion treatment; and
depositing a superconductor layer to overlie the first opposite major surface.

37. The method of claim 36, wherein ion treatment is a plasma treatment.

38. A method for treating a substrate for a superconductive device, comprising:
polishing the substrate, the substrate having a dimension ratio of not less than about 10²;
cleaning the substrate, cleaning including immersing the substrate in a fluid medium and subjecting the substrate to mechanical waves in the fluid medium;
annealing the substrate; and
subjecting the substrate to ion treatment.
